(19) United States
(12) Patent Application Publication
(10) Pub. No.: US 2011/0023077 A1
(43) Pub. Date: Jan. 27, 2011

(54) METHOD, SYSTEM AND APPARATUS TO ENABLE CONVERGENT TELEVISION ACCESSIBILITY ON DIGITAL TELEVISION PANELS WITH ENCRYPTION CAPABILITIES

(76) Inventor: Colin Simon, Leichhardt (AU)

Correspondence Address: WINSTEAD PC, P.O. BOX 50784, DALLAS, TX, 75201, US

(21) Appl. No.: 12/747,747

(22) PCT Filed: Dec. 12, 2008
(86) PCT No.: PCT/AU08/01828

§ 371 Date: Sep. 1, 2010

(30) Foreign Application Priority Data
Dec. 12, 2007 (AU) 2007906774
Dec. 20, 2007 (AU) 2007907110
Jan. 8, 2008 (AU) 2008900125
Feb. 1, 2008 (AU) 2008900438
Feb. 29, 2008 (AU) 2008900990
Dec. 12, 2008 (AU) PCT/AU2008/001828

(51) Int. Cl. H04N 7/173

(52) U.S. Cl. 725/134

(57) ABSTRACT

The present invention relates to a method, system and apparatus to enable information accessibility on digital panels such as television panel. In particular, the invention relates to a method, system and apparatus to enable multiple sources of information to be displayed independently onto one or more graphics planes of multimedia devices and, where and when necessary, for securing access to information revealed on one or more graphics planes of multimedia devices such as convergent television and digital displays.

### FIELD OF THE INVENTION

The present invention relates to a method, system and apparatus to enable information accessibility on digital panels such as television panel. In particular, the invention relates to a method, system and apparatus to enable multiple sources of information to be displayed independently onto one or more graphics planes of multimedia devices and, where and when necessary, for securing access to information revealed on one or more graphics planes of multimedia devices such as convergent television and digital displays.

### DESCRIPTION OF THE PRIOR ART

There presently exist numerous devices to extend the range of services accessible through a multimedia display device such as a television panel, includes devices that enable:

a) cable or satellite connection for subscription services;

b) a television screen to display and play computer graphics, games, movies, etcetera;

c) a television set to interface with a computer for display of email, video conferencing applications, documents etcetera; and

d) the recording and replaying of received cable, satellite or Internet protocol (IP) content.

The problem with the above multitude of services that are available to be displayed is that they are only available to be displayed independently or as a picture in a picture (PIP—which is restricted to television with two independent tuners or signal sources).

A typical multimedia display device such as a digital flat panel has the following typical configuration:

1. A set top box with dual turners, including a hard drive for personal video recording, maybe connected using the RCA plugs into AV1 input;

2. A DVD player maybe connected using the RCA plugs into AV2 input;

3. A Wii/gaming device maybe connected to the DMI input;

4. A computer maybe connected via the HMI input;

5. A video recorder maybe connected via the SCART input; and

6. Other devices are placed into other input connections

The problem with the above configuration is based on a multitude of hardware inputs and only allows one input to be displayed at a time. The above setup is unable to display a computer output showing a video conference call and stock prices in real time, whilst watching a video.

The concept of convergent television (Internet Protocol Television) is known, being the delivery of television content, Video on Demand (VoD), access to the Web, Voice over IP telephony (VoIP) and other applications using Internet Protocol over a network infrastructure—whether it be publicly or privately delivered.

The problems with convergent television devices include:
a) No independent display of a plurality of content source available for positioning by a user for their taste;
b) No security for individual content sources when displayed;
c) poor picture resolution of broadband delivered content when viewing computer delivered video on HDTV or SDTV screens;
d) lag between selection of application to delivery of application;
e) limited capacity of computer resources to simultaneously deliver multiple content source simultaneously and seamlessly; and
f) the inability of known and established hardware and software components to overcome the problems described above.

Convergent television devices may carry one or more media which contain sensitive information. Such sensitive information may need to be viewed only in selected secure locations as governed by an authorised viewer. The solutions currently available for resolving viewer access involves encrypted keys which are either dynamically available for changing the security levels (such as security keys located on dongles and the like) or SMS/tokens for which the user must have a receiving device to receive a code to subsequently place the code into a computer to display the secure content. These devices suffer from the problems of:

not securing the viewing location thus not limiting the viewing screens to only selected screens which can be dynamically changed as security needs change; and/or

not enabling access rights to be monitored independently by feedback from access to secure content itself. This result in security flaws with the content display.

In modern computing, multimedia display devices are not entrusted with security criteria that overcome these problems and thus results in security flaws. Every device that has a role in displaying secure information may need to be secured such that the display location is verified as secure. To date a display device used in conjunction with other computing components is still poorly secured. For example, with online banking there are vulnerabilities that exist with, for example, the use of software such as key loggers installed on insecure computers, or cameras filming the entry of passkeys, etcetera.
In scenarios where authentication means have been incorporated, the authentication means may, for example, require a user to phone a bank and, in response, will be sent a short alphanumeric key. This may create the separate problems of relying on:

(a) non-instantaneous and non-secure request mechanism(s);

(b) a key that is awkward for humans to use—e.g. if an eight digit alphanumeric key is mistyped, this can result in the user being locked out from the secure information.

Currently known methods to secure or authenticate access to visual display devices suffer the disadvantage that they rely on human interaction or input, with the associated vulnerabilities (e.g., inadequate eyesight or dexterity to punch in an eight-digit alphanumeric sequence; delays in the authentication process owing to reliance on a separate, non-instantaneous communication procedure; vulnerabilities in the authentication process by virtue of reliance on a non-secure mechanism to make the authentication request). This always opens up further vulnerabilities for a “man-in-the-middle attack”.

Other approaches to the above problems have used encryption of the graphics processing unit (see US Patent No. 2003/0140241), which is not currently enabled in convergent television designs (see Australian Patent Application No. 2007906628).

The invention herein described seeks to overcome at least one of the problems of the prior art.

Before turning to other parts of this description; it must be appreciated that the above description of the prior art has been provided merely as background to explain the context of the Invention. Accordingly, reference to any prior art in this specification is not, and should not be taken as an acknowledgement of or any form of suggestion that this prior art forms part of the common general knowledge in any country.

### OBJECT OF THE INVENTION

It is an object of the present invention to overcome, or at least ameliorate, at (east one of the stated disadvantages of the prior art, or to provide a useful alternative.

### SUMMARY OF THE INVENTION

According to the invention there Is provided a Set Top Box (STB) device including:

(a) a processor, wherein said processor is enabled to access and process data, wherein said data is in any standardised video, audio or graphic file format, including MPEG-2, MPEG-4, MPEG-V, WNW, ASF, DIVX, XVID);

(b) a means for said processor to deliver processed data to a plurality of Display Planes, wherein each said Display Plane is:
(i) individually output via said processor;
(ii) received on a Display Means; and
(iii) independently written to said Display Means.
   It is important to note that reference to a “set top box” includes units built into televisions, displays, panels, computers and recording devices taking the form of software and hardware units. Those skilled in the art would recognise that all references to set top boxes would also apply equally to built-in versions and other peripheral versions such as computers etcetera.

### BRIEF DESCRIPTION OF THE DRAWINGS

A preferred embodiment of the invention will now be described by way of example only, with reference to the accompanying drawings in which:

FIG. 1 is a screen shot of a convergent television system according to a preferred embodiment of the invention showing a digital Display Means comprising an application source selection from a home screen.

FIG. 2 is a screen shot of a display plane showing an EPG selection of channels showing free to air programs currently screening.

FIG. 3 is a screen shot of a display plane showing an EPG selection by channel of free to air programs broadcast in the forthcoming seven hours.

FIG. 4 is a screen shot of a display plane showing an EPG selection of LongText available by channel showing free to air program currently screening.

FIG. 5 is a screen shot of a display plane showing an email account selected.

FIG. 6 is a screen shot of a display plane showing emails available via the selected account.

FIG. 7 is a screen shot of a display plane showing a Browser window for browsing the Amazon.com shopping site.

FIG. 8 is a screen shot of a display plane showing an RSS feed with articles for viewing and a quick view at the base of the selected screen.

FIG. 9 is a screen shot of a display plane showing a status of the applications, ip address and connected mass storage device recording capacity along with other information,

FIG. 10 is a screen shot of a display plane showing the network configuration.

FIG. 11 is a screen shot of a display plane showing a recording folder.

FIG. 12 is a screen shot of a display plane showing connected media drives for storage and display of contents.

FIG. 13 is a screen shot of a display plane showing a data entry point to locate RSS feeds.

FIG. 14 is a screen shot of a display plane showing for search interface as selected for video recording from source channels.

FIG. 15 is a screen shot of a display plane showing a displaying channel search parameters.

FIG. 16 is screen shot of a display plane showing transcoded images.

### DICTIONARY OF DEFINED TERMS

Table 1 a dictionary of terms defined according to the invention. Terms defined in Table 1 are denoted with the use of capitalisation throughout the document. If a term is not capitalised then its plain meaning is to be construed, unless otherwise specified.

TABLE 1
Dictionary of defined terms

| Term | Description |
|---|---|
| Display Means | A Display Means is a means for making data such as |
| | graphics or video visible to a viewer. A Display Means |
| | includes a television screen or digital display panel, a |
| | computer screen, a mobile phone or PDA screen and the |
| | like |
| Display Plane | A Display Plane can take the form of a graphics |
| | plane or a video plane. Graphics and video planes are the |
| | means in which graphics and video streams, respectively, |
| | are displayed in Display Means such as a television or |
| | digital display panel or computer screen. Depending on |
| | the chip associated with a convergent television and/or |
| | digital display (or associated set-top box) in recent |
| | releases, there are two or more video planes and five or |
| | more graphics planes. For example, set-top boxes with |
| | the NXP 8950 processor carries the streaming and |
| | display requirements for two video planes and five graphics |
| | planes. These planes can reveal data at a rate of 81,000,000 |
| | pixels per second and therefore are a suitable means to |
| | occlude and resolve data as viewing security levels change. |
| Set Top Box | The term set top box (STB) is used as a generic term |
| | in the sense that a STB is designed to take the form of a |
| | very small configuration similar to the size of a small |
| | mobile phone with a similar user interface to that of the |
| | iPhone ™ or HTC Diamond ™ phone. Likewise, the |
| | above STB can be incorporated directly into known |
| | hardware, for example, a digital display panel, remote |
| | control device or a mobile phone. |
| Video | The term “video” as used in this specification |
| | includes IP video sources such as Google, Facebook and |
| | MySpace, video-on-demand (VoD) sources including |
| | subscription and non-subscription, free-to-air video |
| | sources, Digital Video Broadcast (DVB) and video sources |
| | otherwise delivered, using streaming with datagram |
| | protocols, such as the Reliable User Datagram Protocol |
| | (RUDP), or alternative protocols such as Stream Control |
| | Transmission Protocol (SCTP) or Real-time Streaming |
| | Protocol (RTSP), either by authenticated means for VoD |
| | access, along with other files, from within “walled |
| | gardens”, or via anonymous access from a variety of |
| | sources or other means, which due to their content, |
| | licensing and distribution means are suitable for accessing |
| | and controlling by a convergent television system. |

The elements of preferred embodiments of the invention are now described under the following headings:

### DETAILED DESCRIPTION OF A PREFERRED EMBODIMENT OF THE INVENTION

A preferred embodiment of the present invention is now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details.

The preferred embodiment of the present invention provides a system, method and apparatus for the effective delivery and receipt of convergent television with the option of providing one or more content displays using a plurality of graphics and video planes displaying content in a protected manner.
The preferred embodiment provides a convergent television system including:

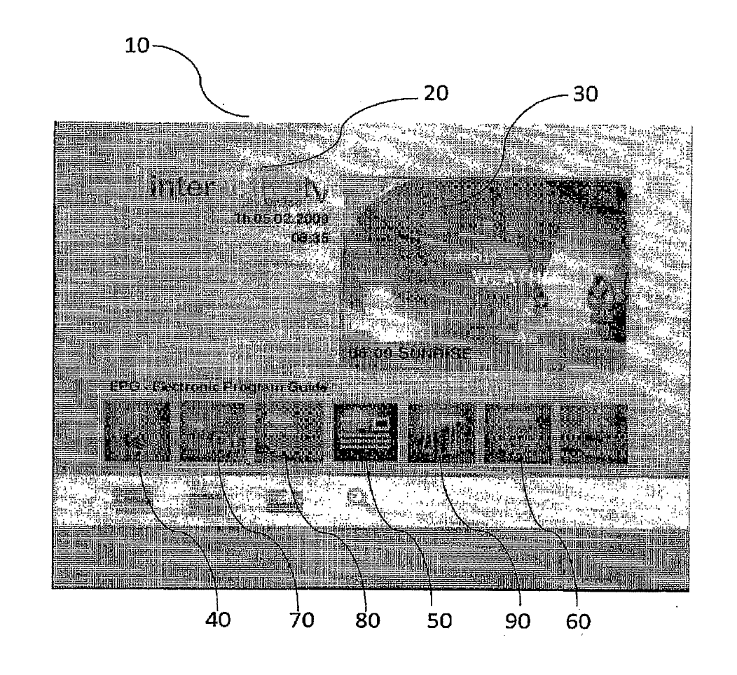

a) A set top box (STB) or equivalent device housing a processor with a System on a chip (SoC), and associated hardware, to enable the following:
(i) One or more virtual machines (VM) installed on the SoC such that the VM processing will be enabled through a BUS to be processed via the chip such that each VM will run an operating system (OS) and one or more applications to process media, data and Information; wherein each VM will have:
i. a first bi-directional communication means to select and receive media (content such as television programs, teletext, Electronic program guide(s) (EPG), video, conferencing, VoIP, etcetera), data and other information via either:
   1. conventional uni-directional communication means (satellite, free to air and cable TV); and/or
   2. the internet, using a separate IP Address bridged to either a hardware or software network card residing either physically or virtually such that standard Internet protocols (e.g. TCP/IP) using available bandwidth to request and receive data;
(ii) an optional second bi-directional communications means between the set top box (or equivalent) and a public or private network such as the Internet. This second communications means utilises a remote desktop protocol from a terminal services application (such as a remote desktop connection or served from the set top box using a known operating system, such as Linux or Windows CE, which is adapted to run on the hardware specified); and
(iii) a Display Means where the VM output is in the form of either an analogue or digital signal to a visual display unit; attached to said STB, for displaying selected communications, such as video streams, wherein the digital display elements are adapted to consumer media viewing and communication enjoyment by having dynamic communication, increased viewing and application selection and satisfactory digital display resolution. Each VM has an individual output such that a plurality of VM outputs are enabled to be viewed on a screen simultaneously dependant on the user's preferences; this arrangement being such that in use the video source is streamed through each VM running via a SoC on the processor housed in, for example, in the set top box, to the allocated visual display unit screen areas so as to enable a plurality of applications to be displayed from a plurality of VMs.
   Each VM utilises one graphics or video plane to dynamically display applications and/or video streams. This enables the media source to be displayed individually and does not require the central mixing of data at a remote server and/or the utilisation of an overlay setup for the display of the data/video stream. Each VM display is alternatively enabled to be mixed, as in the preferred embodiment, via the host OS on the SoC.
   This preferred embodiment allows the user to dynamically display one or more sources of data/video content as required in areas of the display screen that the user so specifies. Further, the use of multiple visual planes for display enables the user to bring forward, backward, make a plane transparent or opaque to protect the display of information displayed on, for example, an underlying plane and/or to move each plane's position and/or size on the screen (or to locks its position and/or size if so desired for information protection purposes). Opaque includes any of form of display of content including text, video, etcetera other than transparent.
   The plurality of planes may be layered or individually positioned so as to optimise the screen. Each plane is enabled to be display on the screen through enabling software.
   FIG. 1 shows a Display Means 10 here as a digital television screen with a Display Plane 20 in the form of a home screen with a selection of application icons across the home screen display plane 20 as a Video Plane 1 showing television 30 superimposed over the upper right hand portion of Display Plane 20. Across the base of Display Plane 20 is a series of icons that, when activated, open additional Display Planes.
   These icons show:

(i) an Electronic Program Guide which takes the form of a Graphics Plane 40 when opened;

(ii) an Email icon which takes the form of a second Graphics Plane 50 when opened;

(iii) a Browser icon which takes the form of a third Graphics Plane 60 when opened;

(iv) a Play list—music/pictures which takes the form of a fourth Graphics Plane 70 when opened;

(v) a setup icon which takes the form of a fifth Graphics Plane 90 when opened; and

(vi) a Video on Demand which takes the form of a second Video Plane 80

The preferred embodiment has the following:

1. the operating system (OS) that is adapted to run on the hardware of the set top box includes a receiving means to collect and retain content from selected sources; and

2. the digital Display. Means is capable of visual display communication, via the set top box, to additional information sources as they become available, such that the user interface on the digital display, which is adapted for use as a means for controlling the STB and accompanying OSs of the SoC and within the VMs.

This preferred embodiment has each VM presenting content onto a single graphics or video plane which makes up a plurality of planes presented to the Display Means. This does not involve mixing via, for example, a remote server; however, if required, a single mixed content stream from a remote server can be displayed on single graphics or video plane.
Consequently, multiple content streams and applications can be presented to the user as the user preferences on a single display. Each content stream and/or application is independently handled by each VM via the STB to the point of display on a separate graphics or video plane on the screen. For example the following applications and video streams are displayed on a single screen:

| | Video or Graphics plane | |
|---|---|---|
| Application | (FIG. 1 reference): | |
| Television | Video Plane 1 | (30) |
| Electronic Program Guide | Graphics Plane 1 | (icon 40) |
| Email | Graphics Plane 2 | (icon 50) |
| Browser | Graphics Plane 3 | (icon 60) |
| Play list—music/pictures | Graphics Plane 4 | (icon 70) |
| Videophone | Graphics Plane 5 | (not shown) |
| Video on demand | Video Plane 2 | (icon 80) |

The use of VMs to enable the availability of multiple image planes is able to convert one format of incoming signal into another format. For example, the video transport streams transcoding into an MPEG2 transport stream to deliver the media to a high definition digital panel can also be utilised to optimise the connection protocols available (for example, HDMI 1.3). Therefore, each VM can be optimising the output for available formats such that the STB is enabled to have simultaneous outputs of multiple formats (one format per VM) so that simultaneously image outputs are enabled as MCMI 1.3, SCART, RCA and/or other suitable outputs.

Conversely, all VM outputs can be mixed into a signal output to, for example, a high definition digital panel using, say, a HEMI 1.3 protocol. This enables a screen with a 1080i resolution to receive a 640×480 output in one area of the screen, along with other resolutions in other areas of the screen such that collectively the screen viewing area is optimised for viewing content from different VMs. For example, one or more icons are present on a display that allows the user to bring up one or more video streams via one or more VMs, where each VM is independent of all other data streams shown on the display.

The preferred embodiment includes a graphics engine application, which is software that performs a function analogous to one or more graphics cards. Therefore, the preferred embodiment is a device that is capable of performing in a manner similar to a device that has multiple graphics cards, but in software form. The graphics engine application generates one or more Display Planes that co-exist on a single Display Means. Each Display Plane represents graphics or video individually output by the processor and independently written to the Display Means. In other words there are multiple Display Planes delivered simultaneously to a single Display Means. In one arrangement, the graphics engine application used is DirectFB (Direct Frame Buffer). This graphics engine application software is located within the SoC operating system (OS) or within each VM located on the SoC.

DirectFB is a thin library that provides hardware graphics acceleration, input device handling and abstraction, integrated windowing system with support for translucent windows and multiple display layers. DirectFB provides a hardware abstraction layer with software fallbacks for every graphics operation that Is not supported by the underlying hardware. DirectFB also provides graphical power to embedded systems.

The SoC has all the processing functionality such as controllers for the USB, SATA, LAN(s), etcetera. A further advantage is that a SoC enables control of the software in that the functionality of the software is updated as required and not modified by the non-technical user. Other embodiments use firmware that updates ROM and operates without incorporating the SoC technology.

### Set Top Box Hardware Platform

A preferred embodiment in one arrangement of the set top box apparatus is now described below.

The hardware platform has the following arrangements:

1. A processor that can incorporate a System on a Chip (SoC) with adequate processing capability. One arrangement utilises a processor such as the PNX8950; however, any other chip with the capacity to have a System on a Chip incorporated/updated onto the chip's memory can potentially be substituted for the PNX8950 processor.

2. Additional memory may be incorporated in other arrangements typically with the following standard configurations:
a. SDRAM: 256 MByte (available for Linux is 128 MByte, other 128 MByte is used for TriMedia cores);
b. Flash memory: 64 MByte/128MByte

3. Optional storage devices (if storage is required) may be added in further arrangements, for example the following storage device configurations:
a. Integrated SATA Hard disk of different sizes (for example, four×250 GByte and/or 1 TByte);
b. Support for mass storage devices such as iVDR removable SATA HDD (1VDR′also possible to be connected via USB2.0), flash drives, and/or solid-state drives (iVDR comes in both HDD and Flash and solid-state)

4. At least one interface from the STB to the digital panel. In further arrangements there may be a plurality of connectors to the digital panel of one or more of the following types:
a. Australian/US/Japan Version of:
   a) RCA connector
   b) HDMI 1.0 1.2 and 1.3 (HDCP integrated in the chipset)
   c) Digital Audio SP/DIF: Coax
   d) S-Video
   e) Component Interface (RGB, Audio Video)
b. European Interfaces:
   a) Scart TV, Scart VCR (loop through)
   b) HDMI 1.0 1.2 and 1.3 (HDCP integrated in the chipset)
   c) Component Interface (RGB, Audio L/R, Video)
   d) Digital Audio SP/DIF: Coax

5. A network interface to the internet, which in one arrangement may take the form of an Ethernet connection in the form a CAT6.1 interface. Additionally, in yet further arrangements there may be a plurality of further data interfaces such as the following:
a) USB1.1 or 2.0 Host connectors (2 interfaces) are to be used to perform the following functions such as:
   a. replay audio and picture files, and video files under specified conditions; and for
   b. allow the user to plug in a dongle to drive a human interface such as a′ Bluetooth™ key board.
b) Wireless Ethernet connections such as a Mini PCI Bus integration for WLAN module, 802.11g, Zcom, XG-603 module; and/or
c) a second SATA connector for an optical drive or iVDR system.

6. Optionally, in yet still further arrangements there may be a STB frontpanel taking the form of the following example:
a) Frontpanel keys:
   a. ON/OFF, UP, DOWN, LEFT, RIGHT, OK, EXIT, PLAY/PAUSE, FF, RR
   b. Frontpanel keys are sent via remote control (RC) events to the system
b) 2×USB2.0 interfaces on the frontpanel
c) The front of the system has an infrared red receiver integrated.

7. Optionally, in yet still further arrangements there may be a one or more digital turners to enable recording and display of multiple channels simultaneously (in other embodiments there may be no digital turners if the STB is used only for display of say Internet sourced TV).

Set Top Box Apparatus

A preferred embodiment of the set top box includes one or more VMs running one or more applications to:
(a) search the Internet, sources of media/data and attached devices;
(b) select, receive and, where necessary, decode programs, data and other information, for example, using standard TCP/IP protocols and other protocols such as mpeg2/4,wmv/asf/DivX/xvid etc as used for video streaming followed by codecs/transcoding means; and
(c) displaying content (including video and other program formats), data and other information on one or more specified areas within a connected digital display which includes a visual display unit (VDU), such that each VM will display on a specified area of a digital display separate from other VM specified areas. These areas can be modified, added, removed, enlarged etcetera as the user specifies.

The preferred embodiment consists substantially of the following arrangement in an integrated circuit:

a SoC that has processing functionality (such as the PNX8950 or any other chip with the capacity to have a System on a Chip functionality incorporated) with firmware containing at least one VM running an operating system, such as a Linux kernel/Windows CE, or a hypervisor containing the option to have either one or a plurality of OS's running, with specific applications and associated libraries, codec(s) and other instructions;

2. a first BUS for connecting to the processor;

3. a optional second BUS for transferring data to and from memory outside of said processor, said memory being shared by the system, processors, and other devices;

4. a plurality of networks including virtual networks or bridged networks such that each VM has an independent IP address or other means for communicating, via the BUS connected to the processor, with:
a) the internet; and
b) one or more connected digital Display Planes to display streamed digital video signals from the VM on the SoC using either flash or remote desktop communication software and analogous software.
   Additionally, the processor may perform additional functions as assigned by a processor's operating system, firmware and drivers. The reader skilled in the art would assume that the set top box would also include required associated components such as a power supply adapted to supply the processor and associated circuitry, as well as a variety of associated hardware devices. Any required codec(s) can be incorporated as on-chip decoders for decoding digital video signals such as MPEG2 and MPEG4 or other input compressions.

### Processor

The preferred embodiment includes a semiconductor which can have a System on a Chip (SoC) incorporated, for example, the PNX8950 NXP (hereafter the 8950), which includes one MIPS processor and two 32-bit 270 MHz “VLIW” media processors called TriMedia processors. “VLIW” (Very Long Instruction Word) refers to a CPU architecture designed to use instruction level parallelism (ILP). The VLIW executes operations in parallel based on a fixed schedule which is determined when the instruction sets are compiled. Consequently, the processor does not need the scheduling hardware, resulting in greater computational power. The VLIW architecture was implemented in the early 1980s and subsequently has increased specifically in the area of embedded systems, which are specific-purpose computer systems designed to perform dedicated functions. This enables the customisation of a processor for an application as an embedded system. Examples of embedded systems include those systems used in personal digital assistants (PDAs), printers, hand-held computers, MP3 players and the like, for providing web page interfaces, such as a mashup, over a network connection for use in specific graphics planes. Embedded systems code is often called firmware, and is stored in memory and is updated by flashing the memory with new firmware.
The inventors in this arrangement incorporates the 8950 for exemplary reasons only and it must be noted that there are chips, other than the 8950, that incorporate a SoC architecture and that have ample processing capability. Therefore, a MIPS, ARM or ×86 processor can be used within a SoC arrangement. The person skilled in the art would appreciate that the 8950 is used for exemplary reason only and this embodiment of the present invention can use any other chip with the appropriate processing and SoC capability.
The 8950 has an embedded MIPS processor having MIPS architecture which is a RISC microprocessor architecture developed by MIPS Technologies. MIPS designs are currently primarily used in many embedded systems including digital set top boxes, digital televisions and PDAs. The 8950 MIPS architecture running at 250 MHz can run one or more VMs with associated operating systems (OS) which can drive the mashup(s) and other web based applications in any graphics plane or combination of graphics planes.
In a second embodiment with the following arrangement, the multicore chips, such as the 8950 which has TriMedla processors, are enabled to use each processor core independently and sequentially, so as to run media functions such as the decoding of high definition MPEG2 content (720p or 10801 up to 18 mbps) as well as Standard Definition (480i/576i)MPEG4, H.264, DivX, and other media codecs and their corresponding audio formats.

Processors With Independent Cores

In this second embodiment, the 8950 utilises the arrangement of the TriMedia processor having independent cores, which enables video streams to be merged with the graphics planes or video planes on external devices with connection dynamics of up to 81Mpixel/second onto one or more Display Planes. This overcomes possible bottlenecks that exist with processors using alternative architectures such as single cores in known convergent television prototypes.
This arrangement further enables an alternate means for conventional video output to high or standard definition resolution convergent television to be converged at slow broadband rates onto digital Display Planes by decoding/transcoding the signal on a separate core before receiving the data stream in the VM which uses flash media or remote desktop protocol or alternative protocols to display the signal on, for example, a digital panel.

### Operating System

The operating systems (OS) used in the above embodiments is an OS that can be, implemented, preferably embedded within firmware, onto a SoC's memory, for example, a Linux or an WinCE OS, or a hypervisor, which in turn wilt house a VM with an OS such as Linux or WinCE.
In one arrangement the control of the OSs, including OS in each VM, includes a display menu or other control means comprising:

one or more graphics planes on an external digital display; and/or

a control panel visual display unit or LED display either incorporated into or attached to the set top box.

In a further embodiment, one arrangement has the host OS and accompanying VM OSs (client OSs running under a VM on a host OS) are adapted to run the hardware specified, and may be operated from a plurality of visually accessible sources, such as:
a primary display source forming the set top box; and
a secondary display source forming the visual display unit, typically a

HDTV or SDTV display, being remotely connected to the primary source.

The secondary display source is preferably connected so that any OS application and/or search interface is processed at the primary source—that is, at the set top box SoC—optionally using flash or remote desktop protocol or like applications. All information, including graphical display information, is processed at the primary source and preferably sourced from the primary display source—that is, the set top box.
The secondary display source further has a receiving means, being a means to receive communication such as a remote desktop protocol, forming the interface of the secondary display source, to enable communication with the desired application on the primary display source such as searching for information or content such as a movie or television program. Consequently, this small STB design is enabled to plug into an internet connection using the likes, for example, of:

a Cat5/6 interface for standard cable connection for gigabit Ethernet and other network protocols,

internet over telephony protocols; or

a WLAN interface,

for internet connection to a digital screen such that the WWW can be displayed on a digital display, albeit a flat plasma/LCD screen, a CRT display or a television with the appropriate connection apparatus.
This STB enables the user to carry a small device the size of, or incorporated into, a mobile phone to plug into any legacy screen to use as an internet connection display device in place of carrying a laptop and other apparatus.

Software Stack

In the preferred embodiment, one arrangement of the Set Top Box system's software stack is integrated to provide the following functionality in its base configuration:

1) Installation assistant: The installation assistant is started when the user for the first time installs the digital system (or after a factory reset). The installation assistant has the following functionality:
a) Allows to install the TV system or other content stream (HDMI and other interfaces)
   (i) Auto detect on HDMI, SCART, RCA or like port;
   (ii) If TV/other content screen supports also HDMI 1.0, 1.2, 1.3 then
      a. HDMI best option auto-configuration of the system will be selected (i.e. if HDMI 1.3 is supported then HDMI 1.3 will be selected). The box chooses the best configuration and then displays the installation assistant; or
      b. If the TV screen does not support HDMI then
   (i) System displays installation assistant in 480p (576i in EU) on HDMI and SCART.
      a. if the user confirms to have picture then continue installation assistant; or
      b. If the user does not confirm to have a picture within a limited time then the system toggles automatically to the next lower resolution. Only when the user confirms two times that he has a picture visible, this picture is displayed and the installation assistant is continued with this configuration;

2) To return to the installation assistant in a running system, the user presses two keys of the frontpanel (FF, FR) in parallel and then the installation assistant starts.

3) The question “Do you see this” is displayed in multiple languages (English,

German, Portuguese, French, Spanish, Japanese, etcetera)
a) Allows to select OSD language (from the list above)
b) Allows to select the location (Australia, France, Germany, . . . Other) is used to select frequency bandwidth and frequency scan range;
c) If “other” is used, the user can provide frequency range and bandwidth.
d) if “other” is used, the user can select a single frequency and single bandwidth and the system searches on this frequency. After this, the system can either search for another frequency or finish the channel search.
e) Performs automatic channel search: All channels that are found are put into list.
f) Allows a user to perform a channel sort, get channel quality parameters and delete a channel.
g) The system checks if it is able to write a file to an integrated hard disk and read it back. if this is not possible it will recommend a reformatting to the user.

4) The host OS or VM OS runs one or more applications that contain the following features:
a)
b) it is possible to change the text font or add new text fonts for future applications of convergent television or for changing the look & feel of the set top box application.
c) application program interfaces (APIs) are enabled so that integration of additional interactive applications can take place such as mechanisms for popup presentation (notification and similar services), picture presentation and all general user interface presentations.

### Electronic Program Guide

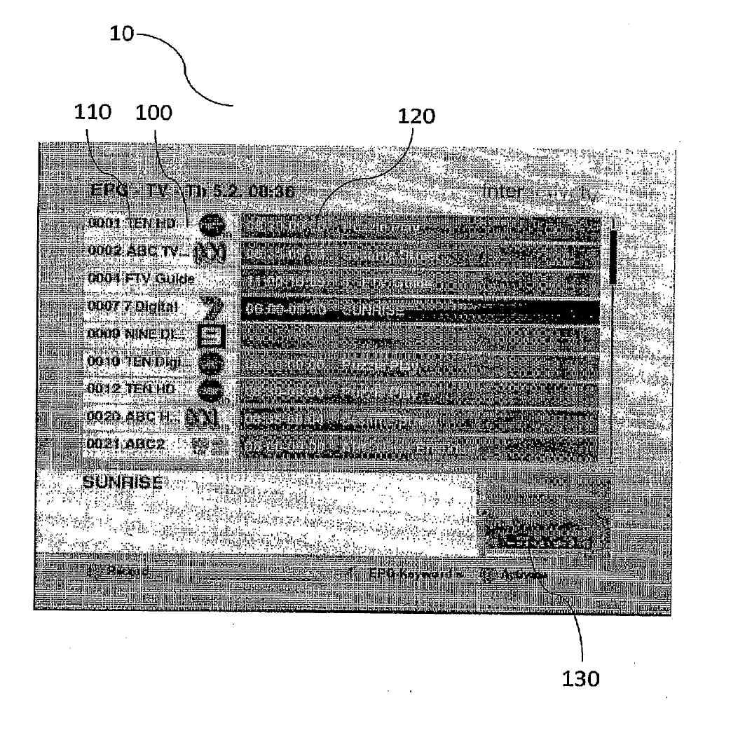

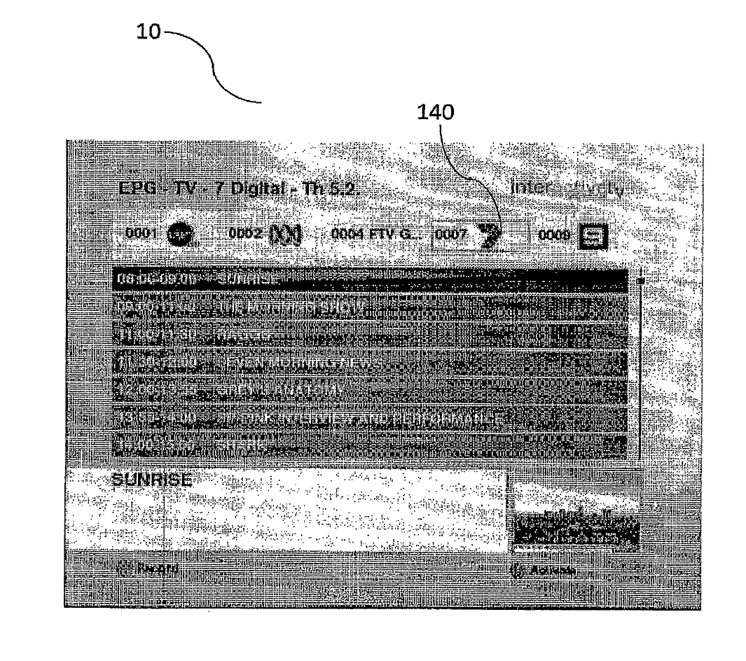

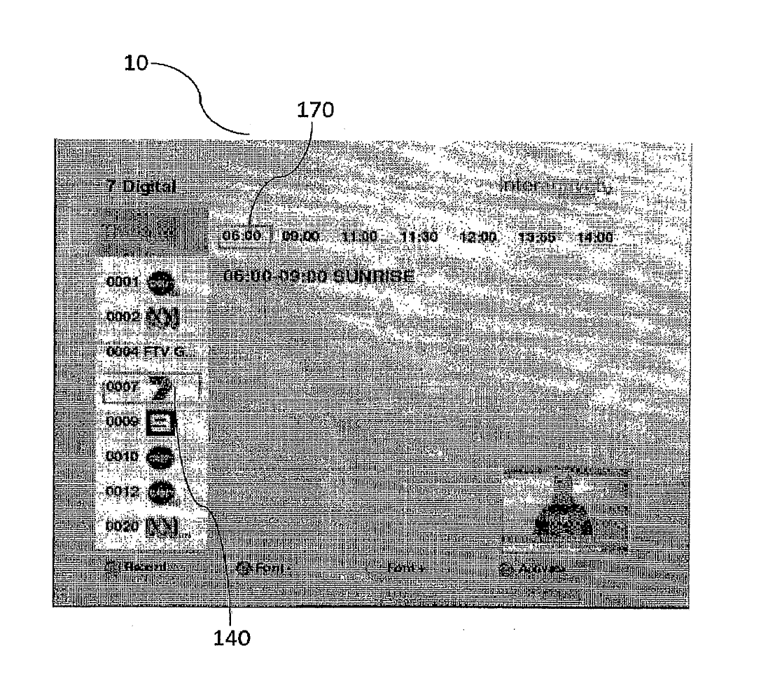

In a further embodiment, as shown in FIG. 2, the EPG Display Plane 100 shows the Free to Air channels 110 available and the programs available 120 and the highlighted channel showing on the accompanying video plane 130. An alternative Graphics Plane is shown in FIG. 3 where the selected channel 140 shows the broadcast EPG stream 150 currently available for the selected channel 140 as well as the long-text information 160 contained with the broadcast EPG stream 150. FIG. 4 shows the long-text information 160 as selected by time 170 for a specific channel 140.

The Electronic Program Guide (EPG) is produced in one arrangement by reading the broadcast EPG stream in real-time such that when a user has specified a program, when such a program is broadcast, it will be recorded. This overcomes the forward programming requirement of one or more EPG publishers. In Australia the broadcast EPG can vary in time so as to be broadcast in only hours ahead, whereas at other time the broadcast EPG may be published in the order of weeks ahead for certain channels. Therefore, if a user wishes to record any broadcast of say, the program “EastWing”, then if the program is listed on the broadcast EPG, then the program is recorded. It does not matter what channel the program “EastWing” is broadcast on.

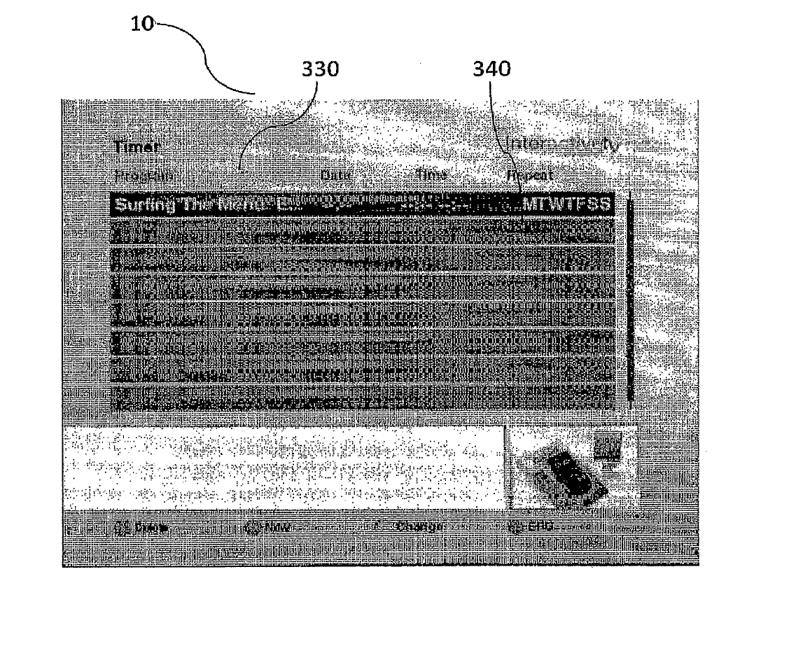

FIG. 14 shows a Program Recording Graphics Plane 330 where the requested programs if broadcast will be recording. The program detail such as the Program Title is entered and searched against the stream EPG broadcast such that when a search term is matched with part of the EPG broadcast then the program will be recorded as shown under the date and time entries. Note that when a nonsense search term is put entered such as “How to have sex after . . . ” 340 then this will not become scheduled to be recorded since no program or long-text description contains these terms. Consequently there is no date or time against this Program entry term.
Reading the broadcast EPG in, for example, Digital Video Broadcast—Schedule Information (DVB-SI) information, the program recording functionality is activated. The EPG information Is presented in three different EPG screens:

a) The EPG-Now window gives access to all TV programs and displays the title of the current and next TV program. Using horizontal and vertical navigation, the user can browse through the overall EPG;

b) The EPG-channel screen displays the EPG for a specific channel.

Navigation here allows to change to other channels and to change the selected TV/radio program; and

c) The EPG-Longtext screen displays the EPG longtext Information for the selected program. Also here it is possible to navigate through the overall EPG by using the cursor keys.

The overall EPG is in one arrangement is stored in a RAM disk/flash memory, so that the user always has the overall EPG available for selecting new programs for recordings. This takes some more RAM size but gives a much better user experience as if only the EPG of the currently selected transponder/channel is displayed.
Even if the user does not use the Set Top Box system, the Set Top Box activates itself automatically and updates the EPG information at a frequency to optimise broadcast programming. This is necessary to update the automatically planned series recordings.
If the system is active and one of the plurality of tuners (preferably two tuners in this arrangement) is available (that is, not used for live TV or Picture-in-Picture or recording), this free tuner is used to accumulate newest schedule information (SI) from other transponders/channels. For this, the Set Top Box software automatically tunes to other transponders/channels and updates the SI information tables.
In one arrangement of the preferred embodiment, the scheduling of ERG recordings is done by the simple click of the RECORD button in each of the three different EPG screens.

a) To define a series recording from the EPG, the user clicks RECORD two times for a given program. The system then automatically records the given program as a series, i.e. schedules new recordings automatically when new EPG data is available. Here the automatic update of the Si information once per day is necessary.

b) If a certain program is scheduled for recording but the program is delayed, the Set Top Box takes this into account and also updates the recording planning.

### Support of Managed EPG

In addition to the DVB-SI EPG, a managed EPG is supported. The system will support in one arrangement a format suitable for each jurisdiction. For example, in the Australian market, if a user subscribes to a managed EPG, then this managed EPG has higher priority than the DVB-SI EPG.
Managed EPG data is delivered via the Internet as, for example, a subscription, pay by use-service or like arrangements. The Managed EPG service provider handles a list of subscribed users (identified by a unique identifier such as a MAC address) to a Digital Video Broadcast (DVB) server on a frequent basis to update Managed EPG content as required.
In a further embodiment, the Managed EPG data from the DVB EPG server is:

a) delivered to Set Top Boxes that are subscribed to the service; and

b) the list of subscribed, boxes can be pushed by a subscription to an EPG provider to the DVB server whenever a new subscription list is provided.

### Recording Functionality:

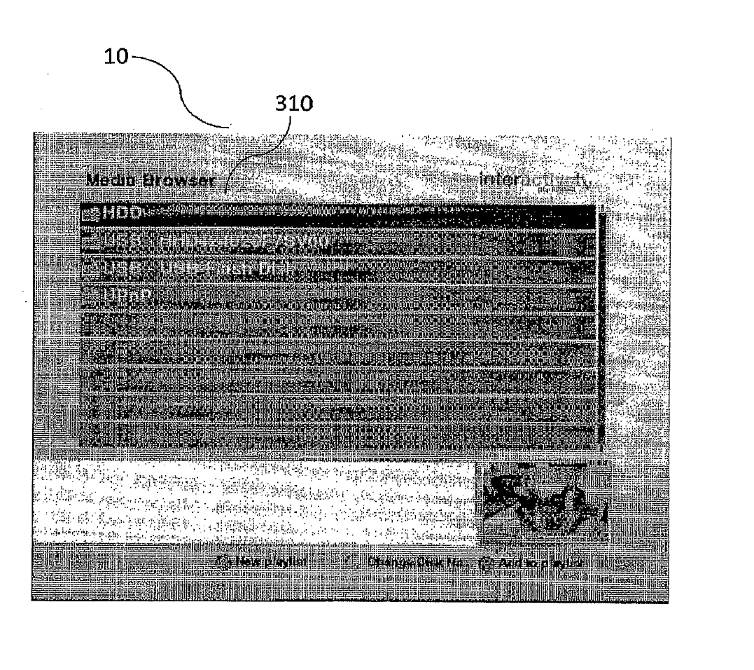

The recording of programs (TV/radio/webcast etcetera) is supported in parallel to the replay of a recorded program. Programs can be recorded in parallel from up to the number of frequencies that are supported by the content sources such as the tuners available (when obtaining the signal from free to air television/radio), This is Similar to the recording of one program and the parallel viewing in timeshift of a second program.
FIG. 12 shows a Media Browser Graphics Plane 310 where a series of available storage drives are shown, and are enabled to be subsequently opened to provide detail of the media recordings available on the selected drives. For conflict handling during planning of recordings or start of a recording, programs are grouped according to their frequency and can be selected for cancellation. If there are n tuners there are maximal n+1 groups of programs.

### Timeshift Functionality:

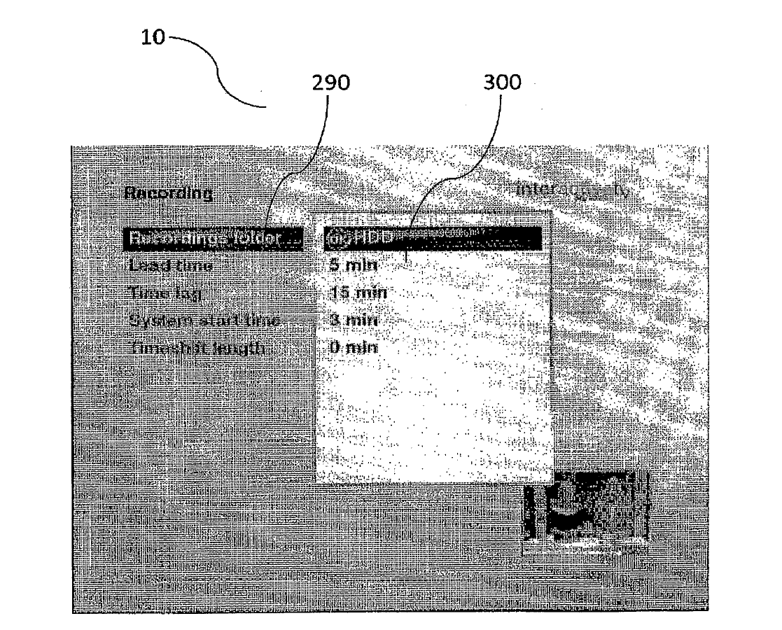

In one arrangement, the timeshift functionality is always on and records the currently visible program, such that it does not have to be individually activated. The timeshift buffer length can be set in settings menu and can be optionally switched off. Thus, whenever the user sees an Interesting program they can rewind the program and watch the interesting scene again. When the user changes the live TV program, the timeshift buffer is cleared.
FIG. 11 shows a Recording Folder Graphics Plane 290 where a Timeshift Graphics Plane 300 provides detail of the TV recording timeshift capacity on the selected hard drive.
Recording can be done onto an integrated hard disk or onto any other storage device such as a USB hard disk that is connected via the USB port or on any PC share that is connected via LAN/WLAN to the Set Top Box. If WLAN is used, the necessary bandwidth has to be available to transmit the digital stream to the PC. If the necessary transmission bandwidth to the USB hard disk or the PC share is not available, the recording is marked as a failed recording and is cancelled.
The recorded content is automatically managed on the internal or external hard disk in a way, that if the hard disk becomes full, the oldest recording that is not write-protected is deleted automatically from the hard disk to provide new space for the starting recording. In this way, the user never has to care about the size of the hard disk. Recordings he wants to keep for a longer time, can be protected (write-protect), so that they are not deleted automatically.

### Timer:

1) The timer menu allows a user to view all scheduled recordings (EPG, timer, keyword);

2) The timer menu allows a user to define timer recordings by selecting channel, start time, end time and date for the recording;

3) The timer menu also allows a user to define timer series recordings by selecting channel, start time, end time, start date and days of the week for that series recording. These series recordings are done fully automatically and the recording planning is updated in regular time intervals;

4) The timer menu also allows a user to define keyword recordings, by providing a keyword and a channel name. The Set Top Box software then compares all programs on the given channel and if the search matches, schedules the program for recording;

5) The timer menu also allows modification of the existing planned recordings;

6) A recording or series of recordings may be set to have a lower priority for conflict resolution than manually programmed recordings, it is possible to view all planned recordings in the timer menu for each series and to resolve possible conflicts.

7) For each recording/recording series, the timer menu allows to select the number of episodes for that series that are stored on the Set Top Box. That is, if 10 episodes are selected to be recorded, the Set Top Box automatically deletes the first episode if the episode number 11 starts recording. In this way, the content is managed automatically on the hard disk.

### My Recordings Menu

A further embodiment has a “My recordings” menu which:

1) lists all the finished ongoing recordings according to their start time (last recordings first);

2) shows all recordings that belong to a series (see above) that are listed within one folder for each series. The name of the latest recording for that series is visible in the list of all recordings. The other recordings for that series can be accessed by selecting the last episode using the OK button;

3) allows recordings to be deleted from the hard disk or alternatively, allows a user to mark the recordings as write-protected so that the automatic content management does not delete them;

4) if a recording is played back for the second time, the user can select to continue at the position where it was stopped the last time, or ₜo view the overall recording from the beginning;

5) for each recording, the full EPG information is stored on the hard disk together with that recording, so that the EPG information is always available; and

6) for ongoing recordings it is possible to change the end-time of the recording.

### Media Locator:

In another embodiment, there is a “Media Locator” enabled which allows a user to select media assets on the integrated hard disk, or on other locations, for example, on a USB2.0 storage device or on a connected PC share or on connected UPnP servers. In one arrangement, the Media Locator allows:

1) a user to play back stored MPEG and H.264 streams, MP3 files and pictures (JPEG, gif, png) and all other formats supported by the NXP system;

2) the media assets (audio, video, photo) to be arranged into playlists so that the playlists can be played back automatically and present title, ID3 tag information and other information is presented in parallel to the replay;

3) a media asset within a directory when selected, allows a user to play back only this single media item or all items of the same kind that are stored within the directory in a linear/random or other order; and

4) the selection of picture and an audio playlist to be played in parallel.

The Set Top Box system provides functionality for the management of media assets on a storage device such as an integrated hard disk/external USB2.0 hard disk (or the connected PC share) devices by allowing the user to copy/move media files from the internal hard disk to the USB2.0 hard disk and vice versa. There is enabled a special control User Interface (UI) page that lists all the currently active transfer jobs. This page allows the user to pause/resume transfer jobs as well as the cancel them. If the recording of TV/radio programs is affected by the transfer jobs, these jobs are paused before the recording is cancelled.

### Live TV, Picture-in-Picture, Radio, Playback of Recordings:

In a further embodiment, the STB allows the user to playback live TV, live DVB-radio, recorded TV/radio programs and other content sources from internal and external storage devices.
In one arrangement of this embodiment, the user is enabled to, during a replay of live TV or during replay of TV recordings, select the audio separate to the image and other data such as videotext.
For example, multiple audio streams may be selected for recording and on replay the user can decide what audio they wish to listen to. For example, for a sporting event covered by several channels, the picture recording may be excellent from one channel; however, the commentary may be better from another channel, such that the selection of sources of image and sound can be optimised for the, user's tastes.

In a further example of this arrangement, the Set Top Box module enables a Picture-in-Picture (PIP) presentation of, in the case of two turners, either two live TV channels or one live TV channel and another TV recording. The PIP function is invoked with a key on the remote control displaying the last live TV channel that was used, This channel can then be changed. In case of two ongoing recordings, the currently recorded live TV programs are presented as PIP. The arrangement enables the user to change the audio of the two TV programs, so that the first or the second TV program can be made available on the loud speaker. Likewise, in this arrangement, the Set Top Box software integrates a Videotext decoder. The decoder caches all Videotext pages on a given transponder such that VideoText can be made available as individually selected.

A further advantage for selecting the audio separate to the image and other data such as videotext is that lip-syncing of the audio to the visual display is enabled.

### Setting of the Set Top Box System:

The STB is enabled to support a large amount of settings that control the overall functionality of the Set Top Box system. The following settings are present in different embodiments as in either the firmware on the SoC or within the VM to enable the following:

1. TV settings for HDMI, Scart, and other formats:
a) TV output (RCA I Scart or HDMI) depending on locality and hardware configuration;
b) HDMI formats (depending on chip platform capability and on digital panel specifications—for example, the TV set);
c) Resolution for example; 576i, p575p, 720p, 720i, 1080i;
d) Aspect Ratio (image format) for example: 4:3, 16:9 only valid for Scart/RCA output;
e) Stretching for example: Letterbox, Pan & Scan (for Scart/RCA output);
f) Frequency for example: 50, 60, 200 hz; and
g) User selections such as Picture in Picture position setting.

2. General settings such as click sound on remote control (RC) key press, transparency of the UI, menu language change, and many others)
a) Key sound (default: deactivated);
b) Display time: Information bar (Infobar) display time;
c) On-screen display (OSD) language: see above in Installation assistant;
d) Audio output: Analog stereo or digital (SP/DIF);
e) Slideshow: display of pictures in picture slideshow (3, 4, . . . 30 seconds, infinite);
f) Factory reset: Resets the system to factory defaults and reboots the box; and
g) EPG mode: Managed EPG or SI EPG.

### Time Zone Settings:

Allows users to select the time zone where the box is located. if the Set Top Box system is connected to the Internet it updates the time over the Internet.

### DVB-T Channel List:

1) Sort channels: Select single channel and move up or down

2) Delete channel: Using specified button (for example, the RED button) followed by confirmation;

3) Get channel signal strength and SNR: Using specified button (for example, the YELLOW button) ;

4) Each channel is enabled to be selected if the recording is started/stopped according to the time of the Set Top Box or according to the SI-event information that is sent by the broadcaster. The default setting for this is the time;

5) For each channel it can be selected if this channel can be used as a source of valid time information, i.e. the system time is updated only on channels that are trustworthy.; and

6) The system supports Logical Channel Numbers (LCN) and adapts to the operational bulletins as specified by standards such as the Digital Broadcast Association (DBA).

DVB-T Channel Search (see Installation assistant)
A channel search is enabled to be selected from a variety of sources including by the following means:

I. Location: Enter the location (see installation assistant);

II. Manual channel: select the frequency (up/down goes to previous/next frequency) and then does the search; or

III. Automatic: automatically scan the frequency range (according to location) and do complete search.

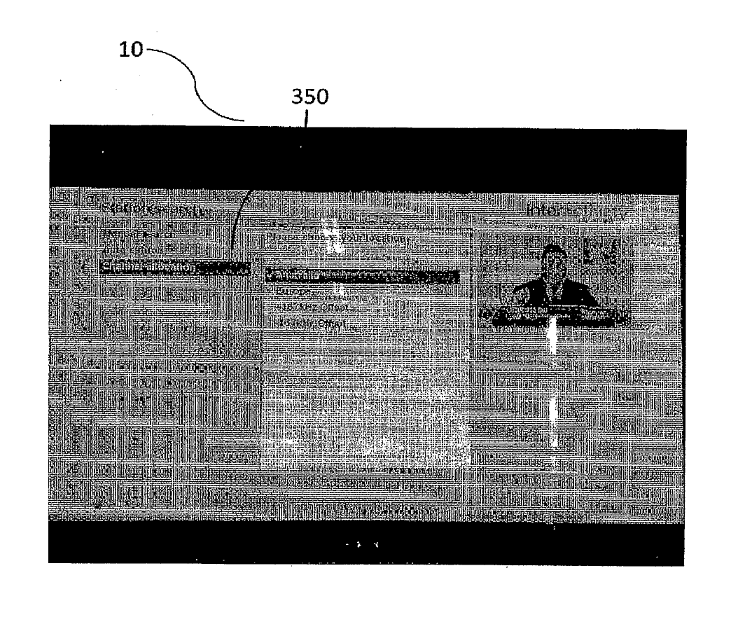

FIG. 15 shows a Station Search Graphics Plane 350 which is displays the tasks listed above.

### Recording Settings:

Recording setting are selected according to the settings of:

a) pre-run and follow-up time;

b) recording location I folder; and/or

c) recording device (storage devices such as internal hard disk or external USB hard disk or PC share).

### Software Settings:

The installation of an updated/new software that is available at a remote location or alternatively on, for example, a storage device such as a connected USB storage device or on the PC share. The methods for installation of new software are:

a) Manual software update: select a file from a location such as a USB HDD or PC share to be updated;

b) Automatic software update: All attached HDDs are searched for the latest software version. Once a later software version is found the user can install this after confirmation; and/or

c) Internet/TV connection services: Using this option the system connects to a TV connection service server and checks if new software is available. If so it presents the feature list and then asks for a software update on the STB. If the user confirms this, the software is installed.

### Information is Available for Display, Including:

1) Status information like software version, hardware version, available size of HDD, is provided;

2) Format of HDD: The integrated or external HDD can be formatted using this functionality;

3) Check of HDD: The integrated or external storage devices such as USB HDDs can be checked for integrity. This is necessary if the user does not unmount a USB HDD but unplugs it without unmounting it If the system starts recording and detects that a hard disk is connected to the Set Top Box system (USB2.0 disk) that is not ok for recording, i.e. was unplugged without unmounting before, the check of this USB HDD is done automatically; and/or

4) Status HDD: Here the storage devices can be mounted/unmounted as desired.

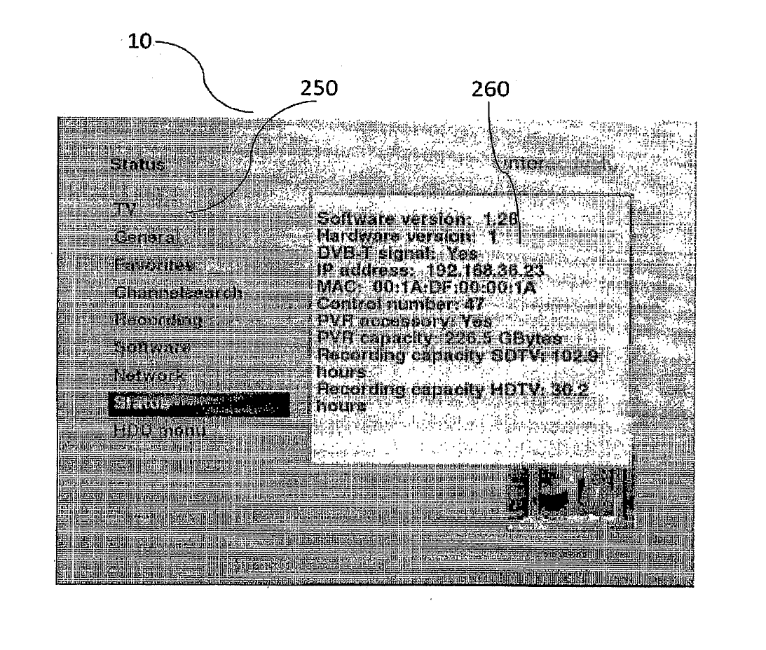

FIG. 9 shows a Status Display Graphics Plane where a further Status Detail Graphics Plane 260 provides detail of the TV recording capacity of the hard drives, network information such as IP address and other detail as discussed above.

### Home Networking Support Integration of UPnP AV Stack:

A further embodiment has a Universal Plug and Play audio visual (UPnP AV) stack which enables the following functionality:

1) UPnP AV client: The client can be activated optionally. If the client is activated it is possible to send content from other sources (e.g. PC) from the PC to the Set Top Box system for display;

2) UPnP AV server: External UPnP players can stream content from the Set Top Box system using the UPnP AV server on the Set Top Box system;

3) UPnP AV control: Using the UPnP control it is possible to identify other UPnP devices in the network and send content from any media server in the network to this identified device;

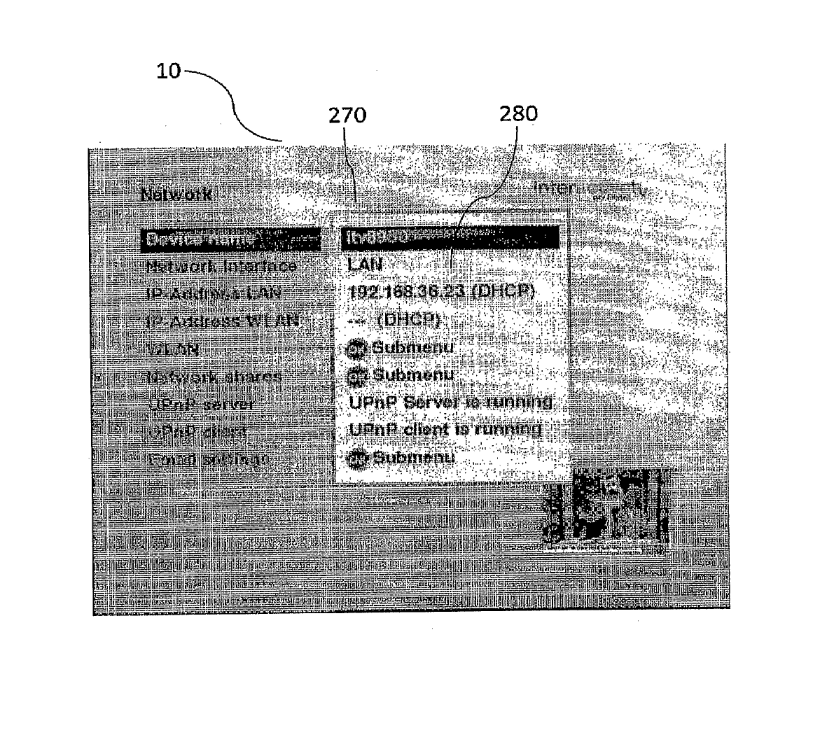

4) Digital Media Attachment (DMA): The DMA runs a similar application than the main Set Top Box but restricted to UPnP functionality, connection to PC shares and Internet services. The following functionality is supported:
a) All functionality of UPnP server access;
b) Access to live TV/radio channels received by Set Top Box (conflict resolution is done on Set Top Box only and satellite clients are informed about it. In a later phase, the concept of “users” is introduced where the priority is determined by the user ranking);
c) All functionality of PC share access (playback of media form PC shares);
d) All Internet services that run on Set Top Box system. Examples of these internet services include TV connection services, which are activated via an Internet portal for a limited time, where after the first start of the system the connection services will deactivate after a specified period if the user has not bought the connection services functionality;
e) The Set Top Box and the DMAs synchronize:
   Timing information
   PC share information
f) The EPG menu containing MyRecordings within the Media Browser menu are visible on the DMA.
   FIG. 10 shows a Network Graphics Plane 270 where a further Network Device Detail is shown in a further Graphics Plane 280 which provides detail of the LAN network such as DHCP, IP Address, UPnP server and client availability and other detail as discussed above.

### Internet Services:

A further embodiment has Internet services enabled including at least one of the following:

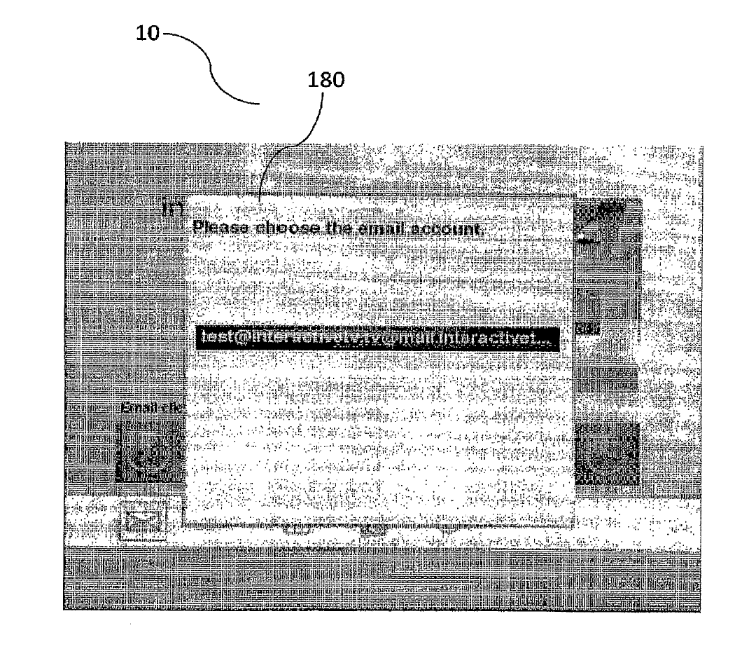

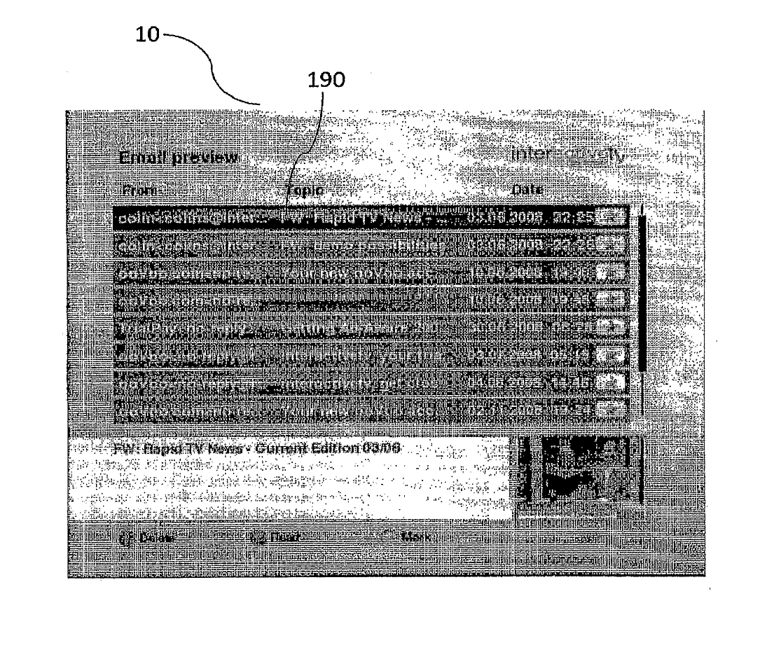

1) E-mail: Pop3, IMAP4 email notifier and e-mail reader. Multiple user accounts. Show incoming mails for all activate user accounts (accounts can be activated/deactivated). In the mail reader the first selection is for the user account. This email account selection is shown in FIG. 5 as a Graphics Plane 180 superimposed in an opaque manner over the Home Screen 20. In FIG. 6 an email preview Graphics Plane 190 is shown;

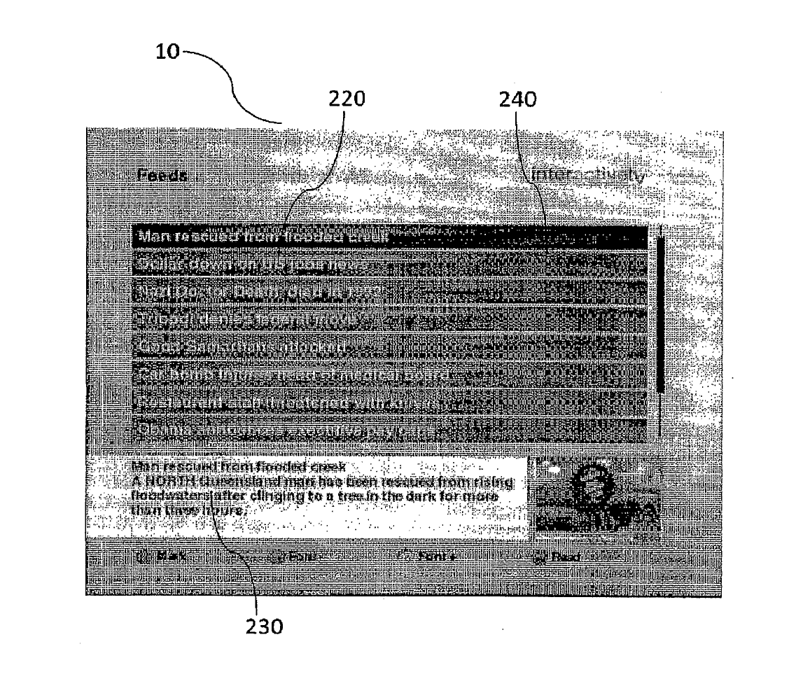

2) RSS feeds is shown in FIG. 8 where an RSS feed is selected giving a choice of topics 240 and showing the RSS contents 230 of the selected topic at the base of the RSS Graphics Plane 220:
a) RSS feeds are selected from a larger list using the associated with services such as TV connection services portal web page (see below)
b) RSS feeds are presented on the STB/Set Top Box
c) Using the browser an RSS feed URL can be added to the list of RSS feeds;

3) Web Browser: Opera for Devices Browser points to a walled garden;

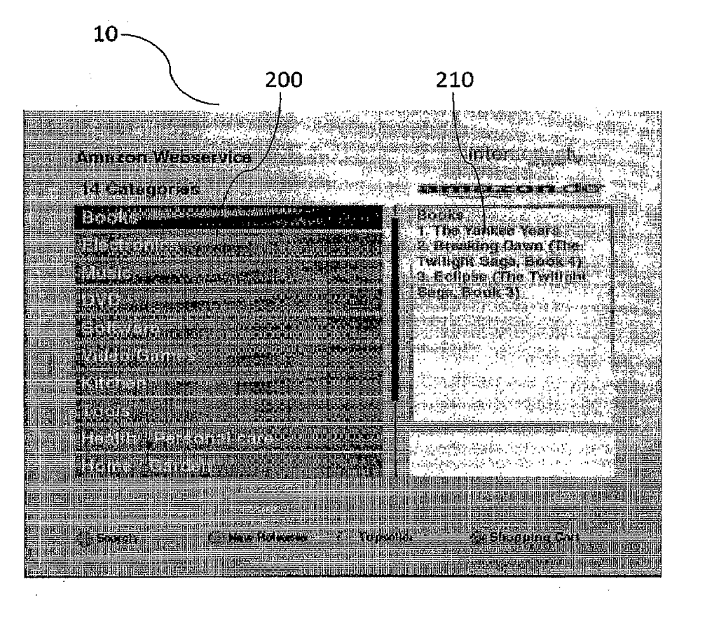

4) Amazon.com: FIG. 7 shows a Graphics Plane 200 for the Amazon.com web site for on this example, it enables Australians to buy on the US site which when a category is chosen such as book then a further graphics plane 210 is opened to summaries the content of the category;

5) CallerID presentation: IP Videophone telephony (e.g. Skype);

6) Social networking applications like MySpace, Facebook, Biba, etcetera;

7) Instant Messaging;

8) Internet Radio channels/Internet Video channels; and

9) E-commerce sites for music/media/software download.

### Rescue System

A rescue system is integrated so that factory reset and software upgrade can be done in case that the flash file system is corrupted. This can happen in case of a previously interrupted software update. The rescue system can be invoked manually when the boot process is interrupted 3 times in a row. The boot process is interrupted by taking the power plug out directly after start of the boot process.

The user interface is set for 576i, 720p and 1080i mode. For all these modes the user interface is adapted, i.e. provides a different number of rows and columns depending on the UI screen and the resolution chosen. The different resolutions are described by XML files and can easily be adapted to the requirements of the user.

Preferably, the secondary display source has an application and search interface to store and display video, audio and other data, via the set top box, when desired. This store and Display Means will preferably be located between the primary and the secondary sources, to store and display audiovisual digital content that would otherwise require re-sourcing from the Internet and downloading via the set top box.

### Storage Means

The “store and display” apparatus of this embodiment can take the form of a Network Area Storage (NAS) device, SAN (Storage Area Network) device, a hard drive(s) including mirrored or RAID device(s), a personal video recording (PVR) or other storage device.

This storage means allows the networking of PVR(s) by the inventive set top box applications to the convergent television system and apparatus. This storage means allows network area storage (NAS) to be connected and disconnected as required, allowing the end user to access the recorded programs as desired, rather than being limited to the availability on the internet. Further, the inventive set top box can allocate access rights via the network address to limit access to specific content, such as inappropriate material for children.

Video from Computer to TV

It is known that television displays have filters to remove vertical flicker when receiving a video signal into interlaced displays. This results in picture filtering of 70% of vertical resolution. Fixed pixel array displays such as LCDs and plasma screens also need a “scaling” processor, which effectively converts an Incoming interlaced picture into a progressive picture. A similar process occurs in a PC and its display with interlaced video. The downside is that interlaced motion artifacts are almost impossible to remove, resulting in horizontal “toothed” edges on moving objects. To overcome this disadvantage, television display manufacturers “overscan” the pictures on their displays (such as CRTs, LCDs) to improve the resolution of the effective on-screen picture. This is processor-intensive and produces delays and limitations in capacity.

The preferred embodiment using, for example, a 8950 chip or like semiconductors with the firmware installed, are enabled to encode image scaling and use a software de-interlacing engine to overcome the image transition problems, as encountered with currently with processor firmware, from computer to high definition and standard definition screens. Another embodiment uses remote desktop protocol and image emulation and therefore overcomes the need to overscan. In this way, picture delivery using this embodiment does not create bottlenecks in processor capacity.

Additionally, software in the form of embedded applications such as Mediamall™ are used to transcode, when appropriate, video transport streams into an MPEG2 transport stream to deliver the media to a VDU such as a high definition digital panel. The transcoding of the transport stream from, for example, Flash involves decoding to a RAW format and then coding to the MPEG2/4/h.264 format for display on the digital panel.

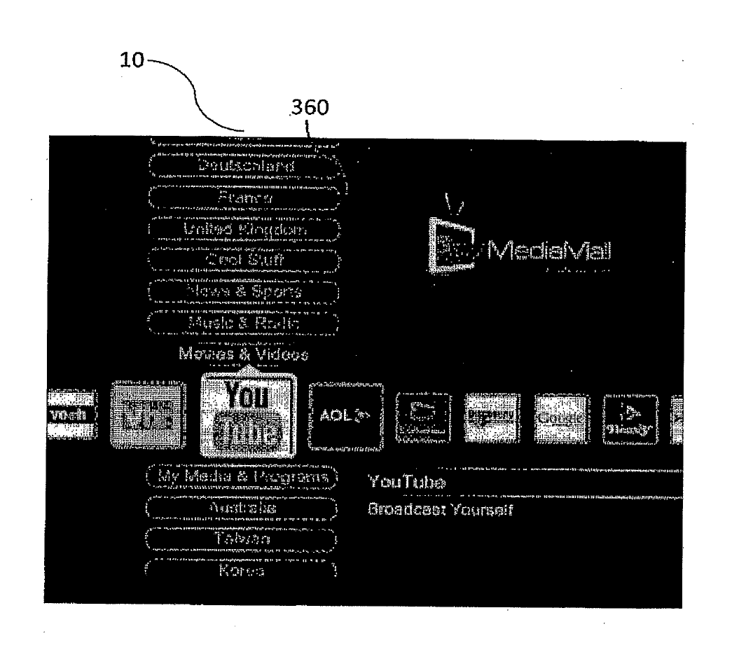

FIG. 16 shows a MediaMall™ Graphics Plane 320 which is able to select content and display the selected content on Graphics and Video Planes on a Display Means.

### DVS to IP

The Digital Video Broadcasting (DVB) output in this embodiment has multiple channels of video and audio output that are enabled to be multiplexed into a single signal which is encoded and packaged via a packetiser into packets with suitable sized payloads to be sent as a transport stream over a network using TCP/IP communication protocol.

On arrival at the set top box, the packets are:
(a) reformed using cyclical redundancy check (CRC) or equivalent file checking applications;
(b) decoded into a single signal (or RAW format);
(c) de-multiplexed into virtual sub channels;
(d) recoded into an MPEG2 format, and
(e) displayed using a thin client or remote desktop protocol onto a VDU such as a digital display device—either directly or via a remote computer protocol.

The set top box processor of this embodiment performs the de-multiplexing as timed with the processor's processing frequency. The 8950 or alternative chip is enabled to generate data at a rate of 81,000,000 pixels per second and therefore can carry the streaming and display requirements for two video channels and five graphics planes. Functionally, video streaming is provided at low operational video on-the-wire rates such as 1 Mbps for excellent audiovisual display quality. No known convergent television device has this capacity.

### Networked Access

The set-top box of the preferred embodiment provides access both to public and private networks. A private broadcast via a private network may use tunneling or remote desktop communication protocols which may have security settings which require authentication/verification. This enables the separate subscriber networks to be established.

The data source, of say VoD, may be located on a NAS or sourced from the Internet through the set top box. It is temporarily stored in the set top box as a cached memory and/or a buffered signal, and is communicated to the VDU such as a digital Display Means using remote computer display communication means such as remote desktop protocol (RDP). The set-top box processor will transmit the video data to the display when the requisite caching or buffer is sufficiently filled, so as to prevent video stalling and poor image quality by underflow of data transmission.

This ability to store audiovisual and other data as a cached or buffered signal in the set top box dramatically reduces the computing resource for convergent television by:

a) reducing any bottleneck on or surrounding the digital Display Means; or

b) maximising accessible digital displays in a standardised TCP/IP networked environment from the set top box and communicated back to the displays using remote communication means.

Personal Digital Displays: “hot screening”

The set top box preferably includes a digital Display Means attached to the visually accessible source of the set top box, wherein the digital Display Means may take the form of a single digital display desktop or “screen-top”.

This embodiment provides a digital display with the ability to set individual logins. This allows an individual to log in, set and access an individualised display desktop or “screen-top”. User preferences for individually selected programs and applications, desired video or information choices to reflect user preferences are stored along with the individual log in.

This enables “hot screening” in an analogous fashion to “hot desking” where a screen login allows an individual's applications and files to be individually and securely displayed when the individual logs Into any screen networked to the set top box.

### Discrete Libraries

In a preferred embodiment an individual user is able to set up discrete libraries of files for different audiences. For example, an individual with one log in can set up a library of suitable content for access, use and viewing by children in the home environment. The same individual, who runs a consulting business, can set up discrete libraries for presentation or other business to business purposes, each library being selected for an individual client.

The set top box will identify the choice of data stream or information source and select the appropriate decoding for each library when required. In a manner similar to hosting of an application, each user, via a display unit, is can send information back to the set top box, as would a client of a computer host (or server), whether it be a thin client, a remote desktop application, a remote procedure call, an applet back or another means for communication by a client—server relationship. An alternate analogy Is where secure information is only able to be displayed in a secure room and not able to be accessed from less secure locations. This is set up via the screen location and MAC address settings of the network card.

### Sampling of Video Segments: Filtering Means

In this embodiment, to ensure that video download or stream is visually accessible via the codec(s), the application and search interface has a filtering means that locates the suitable codec(s) available within the processor and displays sample video as a still image.

In order to verify that a program can be decoded and displayed on a digital display of the preferred embodiment, the incoming videostream is sampled and decoded. One frame of the videostream is taken and displayed in an uncompressed format in a graphics plane against associated metadata such as an electronic program guide (EPG) or text in the form of XML or variants of HTML. A user can see a menu of video programs available to decode and view. This overcomes the problem of downloading polluted and/or undecodeable videostreams.

### Display Mashup and Navigation Across the Display Screen-top

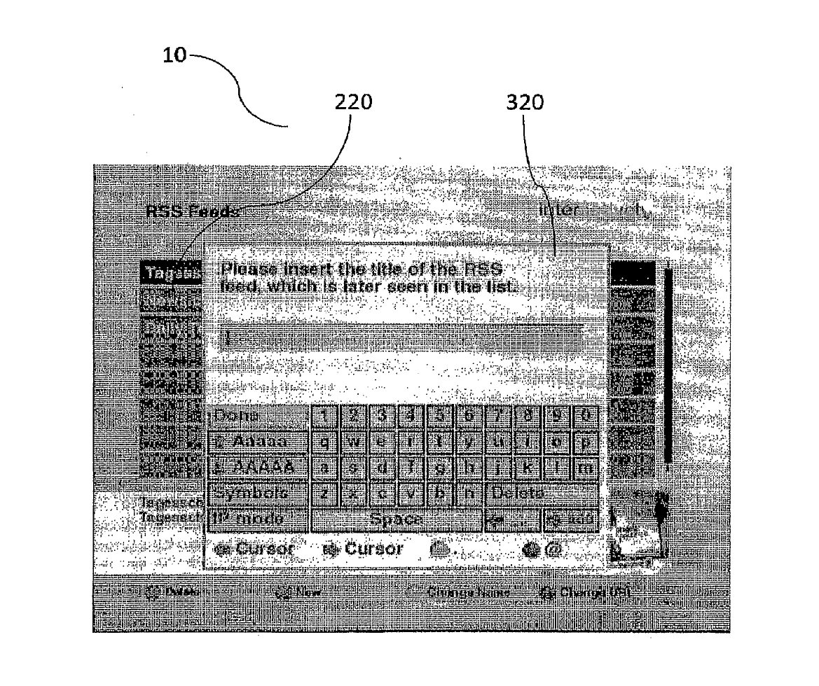

In another embodiment the set top box provides web page interfaces, such as a mashup, over a network connection, for example using web 2.0 (or later standards such as web 3.0 with database functionality). The mashup interfaces with a digital Display Means. The advantages of having mashup functionality Include:
(a) the ability to set individual preferences;
(b) enabling scripting within each mashup component, to enhance the component functionality;
(c) mashup interfacing allows additional applications, interfaces and search screens to be added or removed as user preferences change.
   FIG. 13 shows a Search Graphics Plane 320 which is able to be superimposed over another Graphics Plane such as the RSS Graphics Plane 220 shown such that the content of the underlying Graphics Plane will be searched.

The set-top box processor via the web-interfaced mashup has logic to perform a variety of processes including:
(a) the selection of an application, video (with full functionality such as fast forwarding, pausing, replaying) or other digital files and content;
(b) scrolling across individual applications or channels within applications.

Users are enabled to move across the digital display and select information sources or files, activate programs and otherwise navigate the “screen-top” through use of a remote control handset, a mouse, a joystick, remote keyboard, Wii-like device or other device containing wired or wireless communications means.

Examples of mashup or other multi-screen services available using the preferred embodiment include, for example, VoIP telephony services, banking services, musical entertainment and video, each displayed on a separate screen, or conversely, each on the same screen using separate graphic planes, video planes and audio channels. This may result in a series of screens collectively showing one video broken into each screen as a segment, or alternatively, one screen showing a multitude of different communication channels using picture in picture sub screens.

In yet another embodiment of the invention an application with at least one application program interface (API) enables communication with a variety of data sources. The application is adapted to receive and transmit the source information to a digital Display Means via the mashup interface.

### Three-dimensional Display

This embodiment of the present invention is particularly suitable for displaying three-dimensional images and replicating light generation as would be perceived as those reflected from an original source In multiple dimensions. It is further envisaged that with the use of multiple graphics planes and video planes used in conjunction to simultaneously generate multiple light sources can replicate 3 dimensional auto-stereoscopic or stereoscopic views. Additionally, volumetric displays using multiplanar displays, which have multiple Display Planes stacked up, are able to use this embodiment for efficient 3 dimensional image reproductions. The present embodiment is also enabled for use with Organic light-emitting diode (OLED) screens.

### SCREEN SECURITY

### Limitation on the Retrieval of Sensitive/Copy Protected Information

The ability to dynamically limit the retrieval/display of sensitive or copy protected information to only one (or a specified number of) selected multimedia devices increases the security of the information. An analogy here is the more access points that exist to your bank, the more insecure your banked resources will be. Therefore, in a preferred embodiment, only one multimedia device at a time is enabled to become trusted to reveal sensitive information. This is enabled by the device being included in a “secret sharing scheme” which requires the combination of parts of a key from different sources to be shared in such a way that a threshold is reached so as to allow the multimedia device to share the contents of the key.
The threshold event is only generated when all the “players” share their parts of the key. The sharing of the key is dependent not only on the piecing together of the parts of the key by a single recipient, such as a multimedia device, but must be delivered using two way communication between the “players” at the same time, so that information is only volunteered when all players are present to participate. Therefore, the criteria of events to meet the threshold must include:

a) the presence of each “player”; and

b) the event of volunteering of information by each player;

Therefore, it is mandatory that each “player” can communicate in a bi-directional, secure manner. In the preferred embodiment, the required combination of players includes any device involved in the sharing of information and is enabled via:

(a) use of a multimedia devices that are able to be activated with selected time dependent coded information; and

(b) a wireless communication device (e.g. mobile phone, gaming remote, near-field communication means, remote controller with enablement, etcetera) that can communicate with the main multimedia device. The enablement criteria of the wireless communication device includes a short-range, secure, low-bandwidth wireless communication means that:
i. enables peer-to-peer communication in pairing devices without requiring a login and can act as a virtual connector to secure devices;
ii. transfers codes at appropriate speed to limit interception; and
iii. enables launch In any form of wireless connectivity including Bluetooth, Wi-Fi and Ultra-wideband radio technology.

### A Further Embodiment

### A Further Embodiment of the Invention Includes:

a) one or more devices which act as “players” and the recipients of parts of an encrypted key (e.g. a binary key). The players include:
i. “information display” means such as one or more Display Means for a multimedia device with one or more graphics planes. Each graphics plane has the ability to be “unlocked” through the obtaining of the key; and
ii. “Information request” means such as a mobile phone or other wireless (including Near Field Communication (NFC)) means for communicating with the information Display Means;

b) a server (or grid of servers) which is the “dealer” of the parts of the encrypted key to the devices;

c) a bi-directional communication protocol such as Bluetooth™ or Near Field Communication (NFC) or the like using cryptographic protocols (or an alternative form of secure bi-directional communications technology) that is present in all “player” (devices) involved in the communication or receipt of the relevant information.

In known systems, sensitive information in the form of graphics and/or audio files must be decoded by a suitable secure codec before it can be displayed and viewed (heard) on a multimedia device such as a digital display. This codec is vulnerable since there are other codecs that can be substituted for secure codecs.
In contrast, this embodiment provides a means for securing access to (display of) an incoming secure (which includes copy protected) information such as a video-stream that is an alternative to currently known means that rely on stopping the decoding of the information stream in the absence of a secure key. That is, this embodiment will not display information that is correctly decoded if the secure information does not the key to display the information on the device nominated. The display of information is secured to the display device itself and is not able to be substituted by another display screen.
This embodiment enables one or more graphics/video planes to be locked and Therefore not to be available for screening sensitive (including copy protected) information. In this way, this embodiment offers a new means for ensuring the protection of information. One graphics or video plane (or another specified number of graphics Wanes) on the multimedia device in this embodiment is locked such that is will occlude the viewing of any information contained within or behind the locked graphics plane. This allows one plane, say, to be nominated as the secure plane, whilst other planes are available for normal viewing. Therefore, the digital display is seen by those who need not know otherwise, as a normal functioning digital display.
This embodiment has advantages over relying on decoding of an information stream such as a graphics (audiovisual) stream to secure information (as used by known security systems and methods) in that unsecured information cannot be shown whilst secured information must be locked. The secured information and unsecured information share the same graphic decoder as supplied by the codec distributor. This embodiment overcomes this problem by not using an encrypted codec.
This embodiment also offers the advantage that the secure key can be added in part, in conjunction with other key “parts” being communicated, such that functionality can be added to a multicore chip processor in a retrograde manner (e.g. by updating the embedded software by flashing the chip/memory), separate from affecting the processor performing the decoding steps (which is resource scarce in current prototypes of convergent TV). This is particularly suitable to multi-core processors such as where there is a second processor suited for output of audio-visual data, which can be locked and unlocked as required.
The methodology of implementation of securing information access on multimedia device involves the following steps:

1) A user makes a request to access secure information. This request can be made through secure Internet communications, voice request, or via other means. This request may require a code to be entered via a keypad on an Internet enabled device or equivalent. Conversely, a carrier of an authorised device may be transmitted a key part on a regular basis therefore not involving a request to be made;

2) A unique key is generated by the “dealer”, which in this example is a remote server;

3) Each “player” device has a unique identifier such as:
a. a SIM card in a mobile phone is unique to that mobile phone;
b. a convergent television panel has a unique semiconductor identifier such as a Globally Unique Identifier (GUID);

4) A part of the unique key is delivered to each “player” device. In this example, this would include the following:
a. a mobile phone with NFC (WiFi, Bluetooth or other wireless communications means) activated—in this embodiment, the communication means is, for example, NFC; and
b. a multimedia device such as a convergent television over, for example, the broadband communication channel as a secure key part, with the corresponding communications means (NFC in this example) activated;

5) All “player” devices communicate information or data to make an event occur. The event must reach a required threshold to unlock, in this example, a graphics plane on a convergent television display device to reveal the sensitive transmission;

6) An additional requirement may involve the entry of a code (e.g. a voice code or keyed code) into each device to activate the communication of the key part;

7) Communication of the secure key:
i. establishes NFC between all “player” devices. The NFC must be maintained in order to access the secure information. If the NFC is stopped in any of or between the required devices, then the graphics plane is relocked and the sensitive transmission is stopped;
ii. commences for a time limited period for access to the secure information. For security purposes, the time period cannot be unlimited;
iii. enables other criteria previously set to be met, such as a requirement for a third device to be present before the secure graphics plane is unlocked; these additional criteria can be used to set higher (or different) levels of security; and
iv. enables ongoing auditing of access rights and other information obtained from other data sources, for example, if the rights to viewing secure information are ongoing or to be rescinded.
   This apparatus, method and system far securing information access on multimedia devices according to this embodiment allow a real-time audit of who is accessing what information on which devices and with whom access is being made.
   Additionally, this embodiment enables auditing of information so that broadcast of information from the multimedia access device is only allowed if there are a critical number of secure requests made in a dose proximity of time, therefore enabling secure information to be made to a small group of people that each vouches for the security of the environment.
   Conversely, if a NFC or Bluetooth™ protocol from a device attempts access to a secure graphics plane with a security level that indicates that the owner of the device is not cleared to view information as requested, then the graphics plane is locked out from screening such information. Viewing can take place when other devices have supplied the parts of the key to allow transmission of the sensitive information. That is, one device that does not supply a suitable key part creates an exception event and locks the graphics plane from view.
   Applications for this apparatus, method and system for securing information access on multimedia devices Include video on demand broadcasts where the digital rights management of the broadcast resides separately to the broadcast itself. That is, control of access is regulated via the graphics plane and the means to unlock the graphic plane.
   For example, the following scenario is presented as different arrangement of this embodiment:

1. a consumer may purchase the rights to view ten videos of their choice. Any digital display which is able to communicate in a bi-directional manner and to create an event in conjunction with the consumer's mobile phone, which can allow access to watch the videos of choice on any digital display device selected (so long as they are recipients of part the key that can join with the consumer's part of the key to create an event to unlock the graphics plane). Since there is dynamic bi-directional communication, once the consumer has viewed the ten selected videos, they are then locked out of further video viewing until they have paid an additional subscription for viewing. Here the sensitive information is the right to view commercial video broadcasts, the event is the communication between the mobile phone and the digital display. This event is communicated back to the server and further issuing of key parts to the consumer is determined on the number of videos previously viewed and the number of video viewings paid for;

2. Secure rights may be provided on a graphics plane to reveal sensitive information in only safe locations. Therefore, a request for access to the information from an unsafe display (which is all displays excepts those nominated as safe as conditions change), will allow access to information if the display's GUID or the like is given a part key and the recent of the information is allow given the corresponding part key from the “dealing” server to which the request was made to view the secure information;

3. The graphics plane default setup may be locked to show advertising when a background video or other program is placed into the mode of fast forward, rewind, paused for a specific time period longer than a given threshold (for example, greater than 10 seconds) or some other mode of operation. This locking of information display is enabled to show advertisements during fast forward or similar functions, such that the advertisement is playing in the graphics plane above what the user is skipping using the other graphic planes.

This advertising may be only unlocked on payment of a subscription fee(s), or some other event. The unlocking may be via a technician with an enabled device or, alternatively, the consumer's phone and consumer's digital display are given the required secure key parts after application and approval.
Other application for this protected information is for medical monitoring of patient in their home environment. Each VM display is enabled to monitor a particular medical device such as a ECG, blood pressure, apnea mask, blood glucose and other body measurements, which are enabled to be blended, as in the preferred embodiment, via the host OS on the SoC for review by authorised personnel, such as the General Practitioner remotely monitoring the patient.
Such information may also be set up to instruct a patient such that whenever the television is turned on there Is a separate display reminding the patient to take their medication, ring someone or to change a dressing or monitor a patient using video conference software on one, video plane in conjunction with using graphic planes which monitors a patient's health and provides information to the monitoring personnel. This is an application, for example, to help those who may suffer a particular dementia or have another disorder (or just youthful such as a child who requires reminding of events when preparing for school).

### Other Applications Include:

1. Meetings where confidentiality is required, advise need to be given and documents to be exchanged where the individuals are great distances apart, such that performing the meeting over the web is the most suitable medium. This, for example, may be advice from a doctor, lawyer and/or account; and

2. Training—for example, sport training such that heart rate monitoring takes place in conjunction with instructions from a trainer regarding form, etcetera. Alternatively, such training may be in the form of teaching a programming skill such as writing a program in C#, teaching handwriting, teaching piano playing or learning another language.

Although the invention has been herein shown and described in what is conceived to be the most practical and preferred embodiment, it is recognized that departures can be made within the scope of the invention, which is not to be limited to the details described herein but is to be accorded the full scope of the appended claims so as to embrace any and all equivalent devices, methodology, system and apparatus.

1. A Set Top Box (STB) device including:
(a) a processor, wherein said processor is enabled to access and process data, wherein said data is in one or more of standardised video, audio and graphic file format, including one of the following: MPEG-2, MPEG-4, MPEG-V, WMV, ASF, DIVX, and XVID;
(b) a means for said processor to deliver said processed data to a plurality of Display Planes, wherein each of said plurality of Display Planes is:
(i) individually output via said processor;
(ii) received on a Display Means; and
(iii) independently written to said Display Means.

2. A Set Top Box (STB) device according to claim 1, wherein said means for said processor to deliver processed data to said plurality of Display Planes is a graphics engine application.

3. A Set Top Box (STB) device according to claim 2, wherein:
(a) said graphics engine application is enabled to run on a System on a Chip (SoC); and
(b) said processor is embedded on said SoC.

4. A Set Top Box (STB) device according to claim 3, wherein said SoC is enabled to decode one of the following:
(a) incoming graphics data;
(b) an incoming video stream; and
(c) a combination of (a) and (b) above.

5. A Set Top Box (STB) device according to claim 3, wherein said SoC includes one or more virtual machines (VMs).

6. A Set Top Box (STB) device according to claim 5, wherein said one or more VMs are enabled to run one or more graphics engine applications respectively.

7. A Set Top Box (STB) device according to claim 1, wherein said plurality of Display Planes is enabled to co-exist on a single Display Means.

8. A Set Top Box (STB) device according to claim 1, wherein said plurality of Display Planes is delivered simultaneously to a single Display Means.

9. A Set Top Box (STB) device according to claim 1, wherein each of said plurality of Display Planes is enabled to be resized on a single Display Means.

10. A Set Top Box (STB) device according to claim 1, wherein a Display Plane of said plurality of Display Planes is enabled to be superimposed on one or more other said Display Planes on a single Display Means.

11. A Set Top Box (STB) device according to claim 1, wherein a Display Plane of said plurality of Display Planes is enabled to be re-positioned relative to one or more other said Display Planes on a single Display Means.

12. A Set Top Box (STB) device according to claim 6 including a control means, wherein said control means enables control of one of the following:
(a) said SoC;
(b) said VM;
(c) said graphics engine application; and
(d) any combination of (a) to (c) above.

13. A Set Top Box (STB) device according to claim 12, wherein said control means includes one or more of the following:
(a) one or more frontpanel keys;
(b) an interface to a connect device;
(c) an infrared red receiver;
(d) an LED display;
(e) a display menu on one or more of said Display Planes on said Display Means;
(f) a near-field communication transmitter/receiver; and
(g) other control means.

14. A Set Top Box (STB) device according to claim 5 including a communication means for communicating with a plurality of data sources, wherein said plurality of data sources includes any combination of the following:
(a) a distribution source, including any combination of satellite, free to air and cable TV;
(b) a network source, including any combination of the Internet, a public network, and a private network; and
(c) a data storage medium source, including any combination of:
i. a DVD;
ii. a blu-ray disk;
iii. a CD;
iv. an iVDR; and
v. a hard drive.

15. A Set Top Box (STB) device according to claim 14 including a communication means for communicating with said plurality of data sources, wherein said communication means includes one or more of the following:
(a) one or more Tuners enabled to receive data from one or more of said distribution sources;
(b) one or more network devices enabled to send to and/or receive data from one or more of said network sources; and
(c) one or more connections to one or more of said data storage medium sources.

16. A Set Top Box (STB) device according to claim 14, wherein said plurality of data sources includes data in disparate file formats, wherein said file formats include one or more of standardised video, audio and graphic file format, including one of the following: MPEG2, MPEG4, MPEGV, WMV, ASF, DIVX, and XVID.

17. A Set Top Box (STB) device according to claim 14, wherein said SoC is enabled to run one or more applications, such that said SoC is able to:
(a) search said plurality of data sources;
(b) select, receive and process data from said plurality of data sources; and
(c) deliver data taken from said plurality of data sources, including processed and unprocessed data, to said plurality of Display Planes on said Display Means.

18. A Set Top Box (STB) device according to claim 14, wherein said one or more VMs is enabled to run one or more applications, such that each said VMs is able to:
(a) search said plurality of data sources;
(b) select, receive and process data from said plurality of data sources; and
(c) deliver data taken from said plurality of data sources, including processed and unprocessed data, to said plurality of Display Planes on said Display Means.

19. A Set Top Box (STB) device according to claim 1, wherein said processor includes a plurality of processor cores, wherein each said processor core is enabled to independently and sequentially:
(a) process media functions, including decoding and/or transcoding of one or more data streams; and
(b) independently output each said data stream in a format suitable for display in a separate Display Panel on said Display Means.

20. A Set Top Box (STB) device according to claim 15, wherein said data received from said plurality of data sources is one of the following:
(a) re-formed using a file checking application, including cyclical redundancy check (CRC);
(b) decoded into one of a single signal and a RAW format;
(c) de-multiplexed into a plurality virtual sub channels;
(d) recoded into a file format suitable for display in a Display Panel on said Display Means;
(e) displayed on said Display Means; and
(f) any combination of (a) to (e) above.

21. A Set Top Box (STB) device according to claim 1, wherein said STB includes an automated program recording means, wherein said automated program recording means includes the steps of
(a) reading a broadcast EPG stream in real-time;
(b) searching said broadcast EPG stream for one or more keywords specified by a user, wherein said one or more keywords are contained in one or more of the following:
i. a program title; and
ii. a program description;
(c) identifying all program titles and descriptions in said EPG stream in which said one or more keywords appear; and
(d) automatically recording at a time any program so identified, such that a program is enabled to be recorded without requiring specific user knowledge and input regarding details of time and channel prior to said program being aired.

22. A Set Top Box (STB) device according to claim 21, wherein said STB includes an EPG-search means.

23. A Set Top Box (STB) device according to claim 22, wherein said EPG search means includes:
(a) a means of conducting a search of said broadcast EPG using user-specified search criteria, including:
i. said one or more keywords;
ii. a source of program content, including one or more of free-to-air, cable and satellite channels;
iii. date; and
iv. time
(b) a means for displaying results of said search;
(c) a means to make a program selection, including for one of view and recording, based on said results,
such that a user is enabled to search said EPG, including searching for one or more of said one or more keywords across said channels, said dates and said times.

24. A Set Top Box (STB) device according to claim 1, wherein one or more of said plurality of Display Planes includes:
(a) a locking means, wherein said locking means prevents content in a Display Plane from being displayed; and
(b) an unlocking means, wherein said unlocking means enables content in a Display Plane to be displayed,
wherein said locking means and said unlocking means enables reversible locking and unlocking of Display Plane content, respectively, and such that said STB is enabled to provide independent, secure access to each said one or more Display Planes.

25. A Set Top Box (STB) device according to claim 24, wherein said locking means is a means for individually changing each of said plurality of Display Planes from transparent, to opaque such that when a Display Plane is one of the following:
(a) opaque, content in said Display Plane is locked; and
(b) transparent, content in said Display Plane is unlocked.

26. A Set Top Box (STB) device according to claim 24, wherein said locking means includes a locked first Display Plane superimposed over an unlocked second Display Plane, wherein said locked first Display Plane prevents display of content in said unlocked second Display Plane, such that unlocking content of said second Display Plane is enabled by unlocking of said first Display Plane.

27. A Set Top Box (STB) device according to claim 24, wherein wherein said unlocking means includes:
(a) selected coded information;
(b) said coded information is housed in a wireless communication device, wherein said wireless communication device includes one of the following: a mobile phone, a gaming remote, a near-field communication device, and a remote controller with enablement;
(c) said wireless communication device is enabled to communicate using secure bi-directional communication means;
(d) said coded information is exchanged with said STB via said secure bi-directional communication means; and
(e) receipt of appropriate said coded information by said STB unlocks a specified individual Display Plane.

28. A Set Top Box (STB) device according to claim 27 wherein said unlocking means involves the following steps:
a) a request is made via a Virtual Machine (VM) or a System on a Chip (SoC) through secure communications, requiring a code to be entered via an enabled device to obtain a unique key which is generated by a unique key “dealer”;
b) each device has a unique identifier including one of the following:
a. a SIM card in a mobile phone; and
b. a unique processor identifier;
c) a part of the unique key is delivered to each device, including one of the following:
a. a mobile phone with Near Field Communication is activated; and
b. a multimedia device with the corresponding Near Field Communication means activated; and
d) devices exchange unique key parts to unlock said Display Plane;
such that contents of said Display Plane can be viewed one of directly and on an underlying Display Plane.
